(19) United States
(12) Patent Application Publication
(10) Pub. No.: US 2011/0024064 A1
(43) Pub. Date: Feb. 3, 2011

(54) SPRING ASSIST FOR MULTI BAND ROLLER SHADE

(76) Inventor: Philip Ng, Thornhill (CA)

Correspondence Address: ELIAS C. BORGES, SUITE 406, 555 BURNHAMTHORPE ROAD, TORNTO, ON, M9C 2Y3, CA

(21) Appl. No.: 12/534,127

(22) Filed: Aug. 1, 2009

(51) Int. Cl. E06B 9/56

(52) U.S. Cl. 160/317

(57) ABSTRACT

A spring assist for use with multi banded roller blinds includes a plurality of torsion springs coupled between a roller tube and a shaft. Each of the torsion springs is capable of applying an individual torsion force to the roller tube relative to the shaft. Each of the torsion springs have a first and second end, the first end of each torsion spring being coupled to the shaft and the second end of each torsion spring being coupled to the roller tube. The torsion springs are coaxially aligned and each torsion spring is coupled to the shaft and to the roller tube such that the individual torsion forces of the torsion springs are applied to the roller tube in parallel and the sum total of the torsion applied to the roller tube is equal to the sum of the individual torsion forces.

### FIELD OF THE INVENTION

The invention relates generally to spring assist mechanisms for raising and lower roller shade blinds.

### BACKGROUND OF THE INVENTION

Traditionally, roller blinds for use as window coverings consisted of a single blind panel wrapped onto an elongated roller tube which was mounted in front of the window. Usually, the roller tube was slightly shorter than the width of the window so that when lowered, the roller blind would cover virtually the entire window. The size of the roller tube and the blind panel was therefore a function of the dimensions of the window. Since roller tubes can be fashioned as long as desired, the maximum width of a roller blind was usually determined by the maximum width of the window blind itself, which in turn is a function of the maximum width of the fabric forming the roller blind. For residential applications, single paneled (or single banded) roller blinds are generally all that is required because rarely will a window in a residential property be so wide as to exceed the maximum width of the available window blind fabric. In commercial applications, however, windows can be quite wide. Multi banded roller blinds, namely a roller blind having several separate roller blinds, can be used in commercial applications where very wide windows are to be covered. These multi banded roller blinds generally consist of several roller tubes coaxially mounted to each other and suspended by several brackets. Each roller tube will have a separate blind (band) rolled thereon. The roller tubes can be coupled to each other so that an operator can raise and lower all of the bands simultaneously simply by operating one roller blind chain or motor.

As can be imagined, roller blinds consisting of several different roller tubes and several different blinds suspended thereon can be quite cumbersome to operate. The chain drive used to lift and lower the blind will be rather robust and shall require significant strength to operate because the chain drive will have to simultaneously lift several blinds. A spring assist mechanism is usually provided to help neutralize the significant weight of the bands. However, in order for the spring assist mechanism to generate sufficient torsional force to neutralize the weight of the multiple bands, the torsion spring used for the spring assist must be quite large. Furthermore, a different sized torsion spring would have to be used for each multi banded roller blind since the size of the torsion spring required is determined by the size of the blind (i.e. the number of bands making up the roller blind). Hence, a roller blind having three bands will require a torsion spring capable of generating 50% more torque than the torsion spring required for a double banded roller blind. Furthermore, the more torque a torsion spring is required to generate, the larger the spring has to be, which in turn requires the roller tube to be larger. A spring assist design which permits the use of smaller sized torsion springs is therefore desirous.

### SUMMARY OF THE INVENTION

In accordance with one aspect of the present invention, there is provided a spring assist for a multi band roller blind. The multi band blind consists of one or more bands of fabric blinds wound onto one or more elongated roller tubes which are coupled together. The spring assist comprising a shaft coaxially mounted within the roller tube and a plurality of torsion springs. Each of the torsion spring is capable of applying an individual torsion force to the roller tube. Each of the torsion springs have a first and second end, the first end of each torsion spring being coupled to the shaft and the second end of each torsion spring being coupled to the roller tube. The torsion springs are each coupled to the shaft and to the roller tube such that the individual torsion forces of the torsion springs are applied to the roller tube in parallel and the sum total of the torsion applied to the roller tube is equal to the sum of the individual torsion forces.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1a is a front view, partly in long section, of a multi band roller blind incorporating the spring assist mechanism made in accordance with the present invention.

FIG. 1b is a close up view in cross section of detail A of FIG. 1a.

FIG. 2 is a long sectional view of a portion of a spring assist mechanism made in accordance with the present invention.

FIG. 3 is a long sectional view of a spring assist mechanism made in accordance with the present invention.

FIG. 4 is a perspective view of two spring assist units forming part of a spring assist mechanism made in accordance with the present invention.

In the drawings like characters of reference indicate corresponding parts in the different figures.

### DETAILED DESCRIPTION OF THE INVENTION

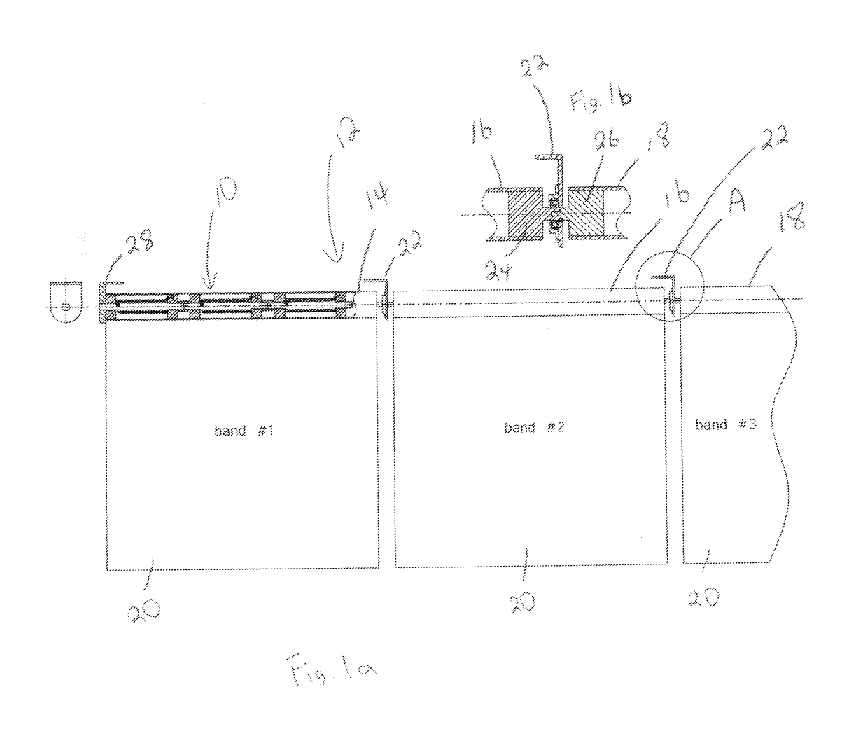

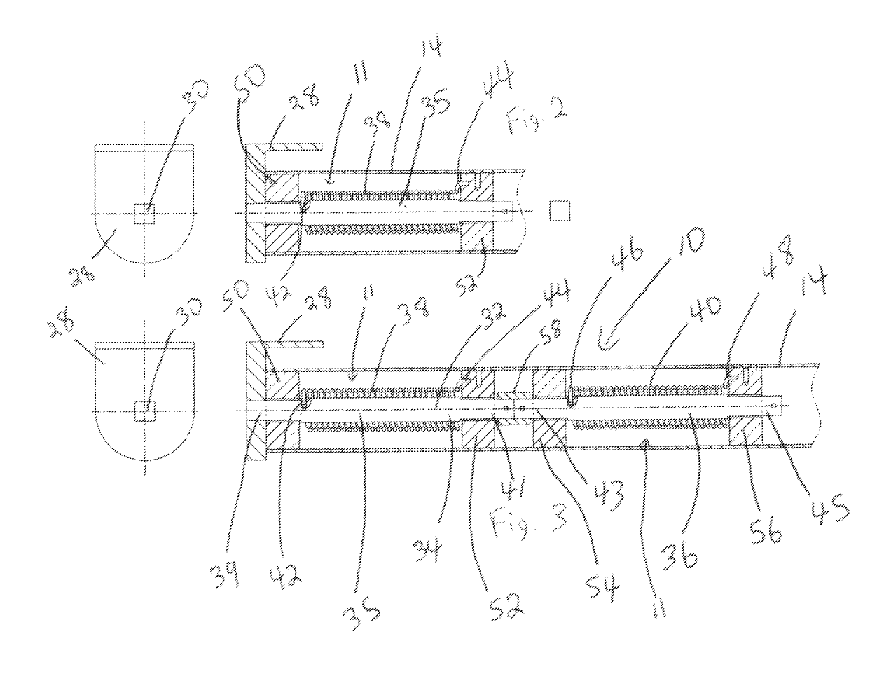

Referring firstly to FIG. 1, a spring assist mechanism made in accordance with the present invention, shown generally as item 10 is preferably for use with multi band roller blinds. Multi band roller blind 12 consists of a plurality of separate roller tubes 14, 16 and 18, each of which have a blind 20 coupled thereto. Intermediate support brackets 22 support adjacent roller tubes. Each roller tube 14, 16 and 18 has opposite ends. In the case of roller tubes 16 and 18, mounting elements 24 and 26, respectively are provided at the ends of the roller tubes. Mounting elements 24 and 26 are configured to be coupled together so that the two roller tubes are physically coupled to each other. Intermediate support bracket 22 is configured to support the coupled roller tubes so that the roller tubes can rotate together as one unit. Therefore, rolling up one band, say band 20 connected to roller tube 14, by rotating the roller tube simultaneously causes other bands to also be rolled up.

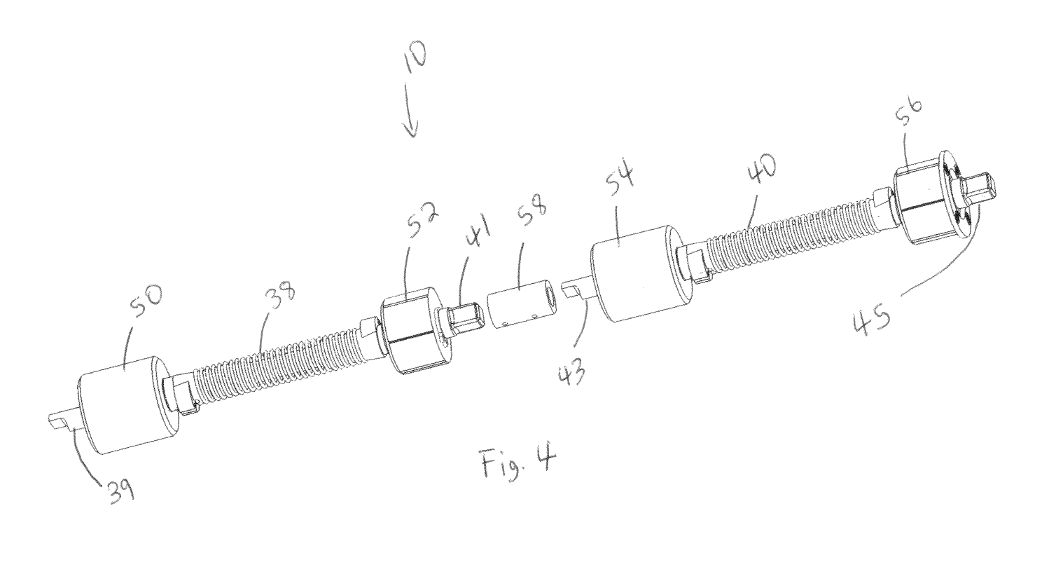

To neutralize the weight of the bands, multi band roller blind 12 is provided with spring assist 10. As seen in FIGS. 2 and 3, spring assist 10 consists of a plurality of spring assist units 11 which are coupled to both support bracket 28 and to roller tube 14. Each spring assist unit 11 includes a torsion spring 38 having opposite ends 42 and 44 mounted onto a shaft 35. End 42 of spring 38 is rigidly coupled to shaft 35 while opposite end 44 of spring 38 is coupled to roller tube 14 via hub member 52. Hub members 50 and 52 are rotatably mounted to shaft 34 to permit roller tube 14 to freely rotate about shaft 35. Shaft 35 is fixed to bracket 28 and cannot rotate. Since torsion spring 38 is coupled to both shaft 35 and to roller tube 14, rotating roller tube 14 causes a rotation in spring 38 which either loads the spring with tension or releases tension in the spring. Spring 38, being a torsion spring, is capable of storing tension and to apply a torsion force to roller tube 14. It is this torsional force (or load) applied by spring 38 which acts as a spring assist and helps to neutralize the weight of any blind coupled to roller tube 14.

As best seen in FIG. 3, spring assist 10 consists of a plurality of spring assist units 11 each of which is capable of applying a spring assisting force to the roller tube to generate a total neutralizing force to neutralize the weight of the blind. Shaft 35 preferably consists of a plurality of shaft elements which are coaxially coupled together to form a long shaft having axis 32. In this case, shaft 35 consists of at least shaft elements 34 and 36 which are coupled together by coupling 58. Shaft element 34 has opposite ends 39 and 41 which have a square profile. End 39 is coupled to bracket 28 by insertion into square aperture 30. Aperture 30 is configured to prevent shaft element 34 from rotating: in this case by its square profile which closely matches the square profile of end 39. End 42 of spring 38 is coupled to shaft element 34 near end 39 of the shaft element while end 44 of spring 38 is coupled to hub member 52 positioned adjacent end 41 of the shaft element. As mentioned above, hub member 52 is fixed to roller tube 14 and rotatably mounted onto shaft element 34 so that the roller tube can rotate relative to the shaft element. Likewise, torsion spring 40 has opposite ends 46 and 48. End 48 of spring 40 is rigidly coupled to shaft element 36 adjacent end 43 of the shaft element while end 48 of spring 40 is rigidly coupled to hub member 56 adjacent end 45 of the shaft element. Again, hub member 56 is rigidly mounted to roller tube 14 and rotatably mounted to shaft element 36 to permit the roller tube to rotate freely about shaft element 36. Support member 54 is rotatably mounted to shaft element 36 and helps to support the roller tube. Since shaft elements 34 and 36 are coaxially aligned and coupled together by coupling 58, and since springs 38 and 40 each have one end rigidly coupled to a shaft element and an opposite end coupled to roller tube 14, rotating the roller tube simultaneously rotates springs 38 and 40 simultaneously. Essentially, since both torsion springs 38 and 40 are coupled between the fixed shaft 31 and to roller tube 14, both torsion springs can be loaded and unloaded with tension in a parallel fashion. As a result, the combined torsional force applied to the roller tube by spring assist 10 (i.e. the total neutralizing force applied by the spring assist) is a sum of the individual torsional forces applied by the torsion springs.

As seen in FIG. 4, the spring assist mechanism of the present invention uses coaxially aligned springs arranged in an end to end fashion. However, unlike prior art spring assists comprising multiple springs, the springs in the present invention are coupled in parallel, not in series. Spring assist mechanism 10 uses a plurality of springs coupled together in parallel such that the total neutralizing force generated by the spring assist is equal to the sum of the individual torsional forces (loads) generated by each of the springs. In a hypothetical example, if the spring assist consisted of three individual torsion springs coupled together in parallel, with the springs applying a torsion force of 19, 20 and 21 Newtons, respectively, then the total torsion force applied by the spring assist would be 60 Newtons (19+20+21). The effect is very different in spring assist mechanisms where the springs are coupled together in series (i.e. coupled together in an “end to end” fashion). If the same three springs were coupled together in series in such an end to end fashion (say by coupling end 44 of spring 38 to end 46 of spring 40), the torsional force generated by the springs would not be the summed together. Indeed, the total torsional force generated by springs in the above hypothetical example coupled together is series would be about 19 Newtons—the lowest individual torsional force generated by the individual springs. Coupling the springs together in series has the effect of creating a single very long spring.

Coupling springs together in series to form a very long spring does not increase the torsional force generated; however, it does increase the number of rotations through which the spring assist can apply the torsional force. In situations where very long blinds are required (i.e. from top to bottom), then a spring assist having a very long spring capable of applying torque over a large number of rotations may be required. It has been discovered that, given the restrictions placed on the maximal height of a majority of windows, it is unlikely that the spring assist would have to apply its torsional forces over more than a relatively few rotation. The reality is that blinds don't have to be very long and are rarely longer than eight feet; therefore, the maximal number of rotations the spring assist must endure is rarely greater than 30 or so. However, there are no similar restrictions on the width of a blind, particularly of multi banded blinds. As a result, wide multi banded blinds require a spring assist mechanism capable of generating much larger torisonal forces over the same number of rotations. This cannot be accomplished by coupling springs in series, and, up until the development of the present invention, could only be achieved by using larger, higher torsion springs. The present invention permits the use of smaller standard sized torsion springs which can be coupled together in parallel. Furthermore, the total maximal torsional force generated by the spring assist can be increased simply by increasing the number of spring assist elements contained in the spring assist. If greater torsion is required, one or more spring assist unit can be added. This provides the installer with greater flexibility.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A spring assist for a roller blind having an elongated roller tube, the spring assist comprising;
a shaft coaxially mounted within the roller tube, and
a plurality of torsion springs each having a first and second end, the first end of each torsion spring being coupled to the shaft and the second end of each torsion spring being coupled to the roller tube.

2. The spring assist of claim 1 wherein the shaft is formed from a plurality of separate shaft segments, the separate shaft segments being coupled together in coaxial alignment.

3. The spring assist of claim 1 wherein the second end of each torsion spring is coupled to a hub member, the hub member being rotatably mounted on the shaft and fixed to the roller tube.

4. The spring assist of claim 1 wherein each torsion spring is mounted onto a separate shaft segment, each shaft segment having a distal end and a proximal end, the first end the torsion spring being mounted adjacent the proximal end of the shaft segment, the shaft segments being coupled together to form the shaft.

5. The spring assist of claim 4 wherein each separate shaft segment the second end of each torsion spring is coupled to a separate hub member rotatably mounted to the shaft segment adjacent the distal end, each separate hub member being fixed to the roller tube.

6. The spring assist of claim 2 wherein the separate shaft segments are coupled together by coupling members.

7. A spring assist for a roller blind of the type having an elongated roller tube rotatably mounted to one or more support brackets, the spring assist comprising a plurality of torsion springs, each torsion spring configured to generate an individual torsion load, the torsion springs each being mounted between the roller tube and the support bracket such that the torsion springs are simultaneously rotated in parallel when the roller tube rotates and the individual torsion loads of the torsion springs sum together to generate a total torsion load on the roller tube.

8. The spring assist of claim 7 wherein each spring has a first end coupled to a shaft which is in turn coupled to the support bracket, and wherein each spring has a second end coupled to the roller tube.

9. The spring assist of claim 8 wherein the shaft is formed from a plurality of separate shaft segments, the separate shaft segments being coupled together in coaxial alignment.

10. The spring assist of claim 8 wherein the second end of each torsion spring is coupled to a hub member, the hub member being rotatably mounted on the shaft and fixed to the roller tube.

11. The spring assist of claim 8 wherein each torsion spring is mounted onto a separate shaft segment, each shaft segment having a distal end and a proximal end, the first end the torsion spring being mounted adjacent the proximal end of the shaft segment, the shaft segments being coupled together to form the shaft.

12. The spring assist of claim 11 wherein each separate shaft segment the second end of each torsion spring is coupled to a separate hub member rotatably mounted to the shaft segment adjacent the distal end, each separate hub member being fixed to the roller tube.

13. The spring assist of claim 9 wherein the separate shaft segments are coupled together by coupling members.

14. A spring assist for apply a neutralizing torsion force to a roller tube of a roller blind supported by brackets, the spring assist comprising a plurality of torsion springs each having opposite ends, the torsion springs being coaxially aligned and mounted end to end within the roller tube, each torsion spring configured to apply an individual torsion force to the roller tube, the torsion springs each being coupled to the roller tube and the support bracket such that the neutralizing torsion force equals the sum of the individual torsion forces of the torsion springs.

15. The spring assist of claim 14 wherein one end of each torsion spring is coupled to the support bracket via an elongated shaft and wherein an opposite end of each spring is coupled to the roller tube by a hub member.

16. The spring assist of claim 15 wherein each torsion spring is mounted to a shaft segment, the shaft segments being coupled together to form the shaft.

17. The spring assist of claim 16 wherein the hub members are rotatably mounted to the shaft segments.
